(19) United States
(12) Patent Application Publication
(10) Pub. No.: US 2007/0029865 A1
(43) Pub. Date: Feb. 8, 2007

(54) Wheel set

(76) Inventor: Ting-Hsing Chen, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/187,974

(22) Filed: Jul. 25, 2005

(51) Int. Cl. B60B 19/00

(52) U.S. Cl. 301/5.1

(57) ABSTRACT

A wheel set includes a primary wheel and two secondary wheels. The secondary wheels are disposed at two sides of the primary wheel, respectively. The primary wheel is provided with non-circular engaging members at the two sides. Each secondary wheel is provided with a corresponding engaging member to be engaged with the primary wheel. Molds for the primary wheel and the secondary wheels can be separately developed so as to reduce the total production cost. When taking a turn, the primary wheel and the secondary wheels are operated together to achieve a smooth turn.

### BACKGROUND OF THE INVENTION

(a) Field of the Invention

The present invention relates to a wheel set applied to a toy car, scooter, skateboard, roller skate, tricycle, bike, and luggage caster, and more particularly, to one that has a primary wheel and secondary wheels disposed at two sides of the primary wheel. Molds for the primary wheel and the secondary wheels can be separately developed so as to reduce the total production cost. When taking a turn, the primary wheel and the secondary wheels are operated together.

(b) Description of the Prior Art

A plurality of wheels is usually mounted to a toy car, scooter, skateboard, in-line skate, tricycle, and bike for children as well as luggage caster. However, any of those children vehicles is generally smaller in size thus to be vulnerable to turn over when taking a turn, presenting more dangers particularly to children who are comparatively poor in operating the toy vehicle.

To make it safer to ride, taking the bike exclusively design for children to learn riding a bike as example, one auxiliary wheel smaller than the rear wheel is each eccentrically provided at both sides of the rear wheel to support the rear wheel for avoiding overturn when taking a turn. However, the adaptation of the auxiliary wheels not only increases production and assembly costs, but also requires more time consumed in assembly because additional members are needed. Furthermore, the bike provided with auxiliary wheels produces high noise level and is prevented from easy maintenance.

A latest improvement teaches that the primary wheel is integrated with the auxiliary wheels provided at two sides of the primary wheel. The diameter of the secondary wheel is the same as or smaller than that of the primary wheel. However, the mold is costly.

### SUMMARY OF THE INVENTION

The primary purpose of the present invention is to provide a wheel set comprising a primary wheel and secondary wheels. Molds for the primary wheel and the secondary wheel can be separately developed so as to reduce the total production cost. When taking a turn, the primary wheel and one of the secondary wheels touch the ground at the same time to achieve a smooth turn.

To achieve the purpose, the present invention includes a primary wheel and two secondary wheels disposed at two sides of the primary wheel. The primary wheel is provided with non-circular engaging members at the two sides of the primary wheel, and each of the secondary wheels is provided with a corresponding engaging member to be engaged with the primary wheel.

The present invention provides the following advantages:

1. The total production cost is reduced because molds of the primary wheel and the secondary wheels are separately developed; besides, when separately developed, both molds are made smaller and the development of the smaller mold is easier.

2. When taking a turn, the primary wheel and either of the secondary wheels touch the ground at the same time to achieve a smooth turn.

### BRIEF DESCRIPTION OF THE DRAWINGS

FIG. 1 is an exploded view of a first preferred embodiment of the present invention.

FIG. 2 is a sectional view of the first preferred embodiment of the present invention.

FIG. 3 is a sectional view of the first preferred embodiment of the present invention in an operating status.

FIG. 4 is a sectional view of a second preferred embodiment of the present invention.

FIG. 5 is a sectional view of a third preferred embodiment of the present invention.

FIG. 6 is a sectional view of a fourth preferred embodiment of the present invention.

### DETAILED DESCRIPTION OF THE PREFERRED EMBODIMENTS

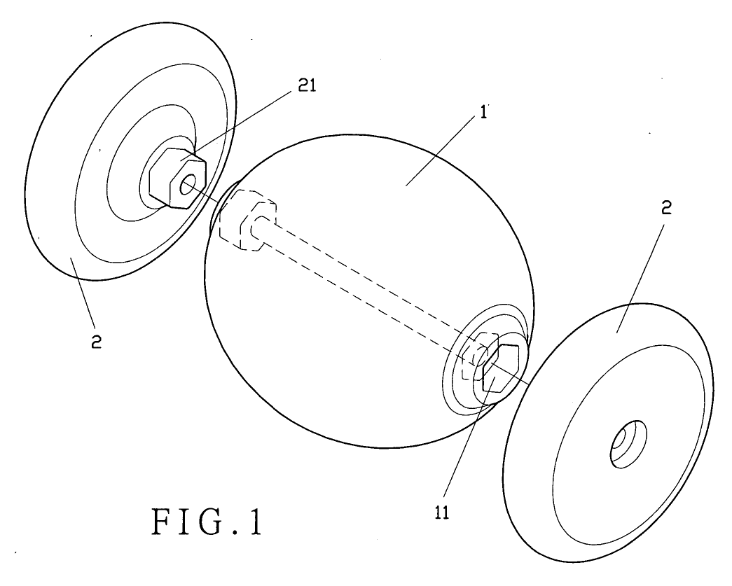

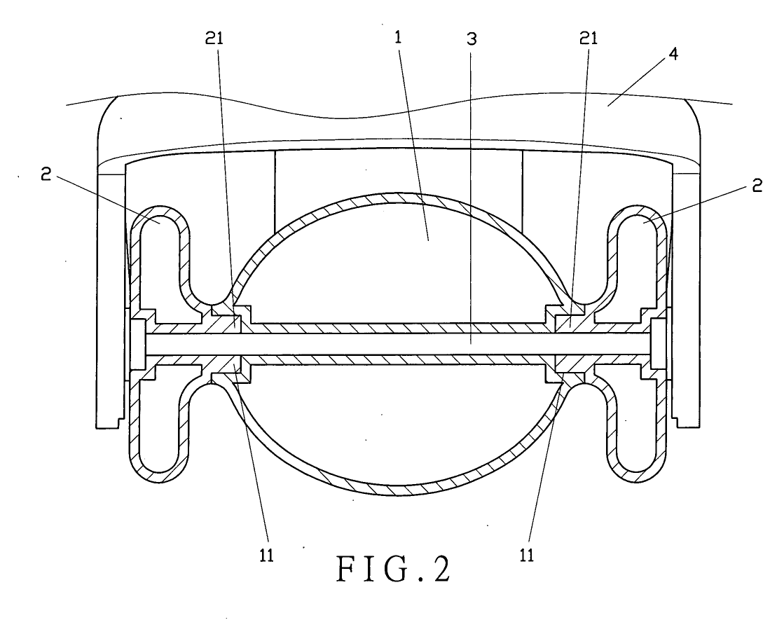

Referring to FIGS. 1 and 2, a first preferred embodiment of the present invention comprises a primary wheel (1) and two secondary wheels (2). The secondary wheels (2) are disposed at two sides of the primary wheel (1), respectively.

The primary wheel (1) is provided with non-circular engaging members at the two sides. In this preferred embodiment the engaging members are engaging holes (11). Each secondary wheel (2) is provided with a non-circular engaging member corresponding to the engaging members of the primary wheel (1). In this preferred embodiment the engaging member of each secondary wheel (2) is an engaging tube (21). In this preferred embodiment the cross-section of both the engaging holes (11) and the engaging tube (21) of each secondary wheel (2) is polygonal. Thus, the two secondary wheels (2) are engaged with the primary wheel (1) by inserting their respective engaging tubes (21) into their corresponding engaging holes (11) of the primary wheel (1). The secondary wheels (2) will not spin in relation to the primary wheel (1).

Molds for the primary wheel (1) and the secondary wheels (2) can be separately developed; and each mold is made smaller for easier development to contribute at the same time so as to reduce the total production cost.

In this preferred embodiment, the outer diameter of each secondary wheel (2) is smaller than that of the primary wheel (1), and each secondary wheel (2) is to be an auxiliary wheel.

Upon assembling the wheel set as illustrated in FIG. 2, the secondary wheels (2) have the engaging tubes (21) to be engaged with the engaging holes (11) of the primary wheel (1), and then the engaging tubes (21) are fixed onto a wheel axle (3). The wheel axle (3) is further to be pivotally connected to a truck (4).

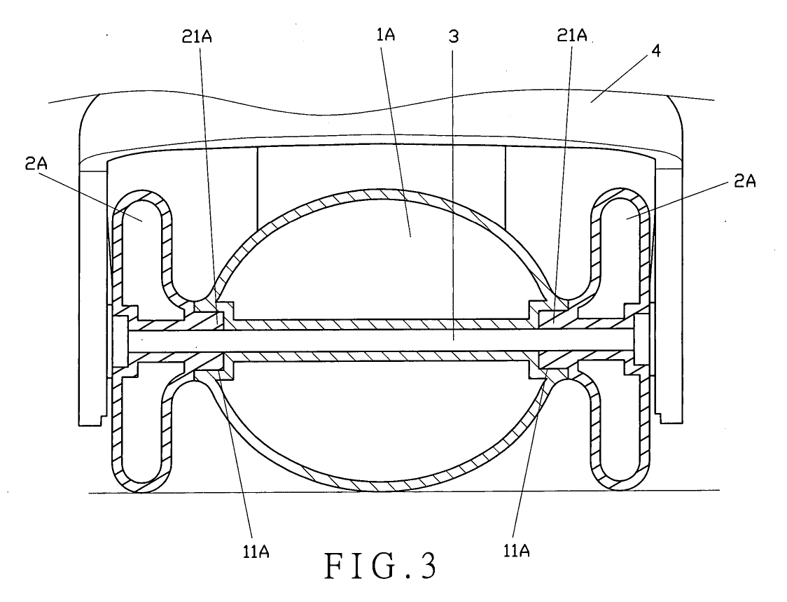

When the wheel set is taking a right (left) turn as illustrated in FIG. 3, the right secondary wheel (2) touches the ground at the same time with the primary wheel (1), increasing the contact area with the ground by the primary wheel (1) and the right. (left) secondary wheel (2) to achieve a smooth turn.

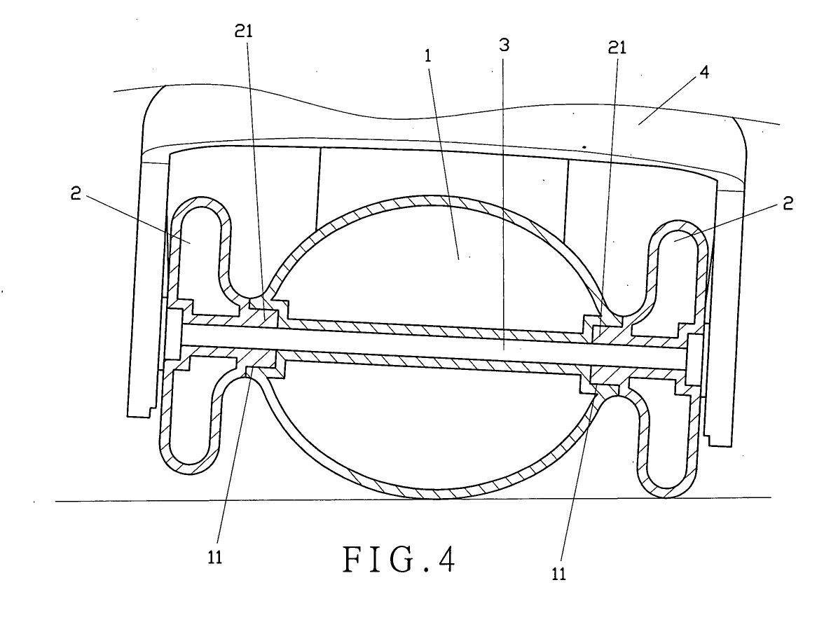

Now referring to FIG. 4 for a second preferred embodiment of the present invention, the wheel set comprises a primary wheel (1A) and two secondary wheels (2A) to form multiple wheels made is in the same outer diameter. Wherein, similarly to that of the first preferred embodiment, the engaging members of the primary wheel (1A) are engaging holes (11A) and the engaging members of the secondary wheels (2A) are engaging tubes (21A) to be engaged with the engaging holes (11A). The engaging tubes (21A) of the secondary wheels (2A) are then fixed to the wheel axle (3). The wheel axle (3) is pivotally connected to the truck (4).

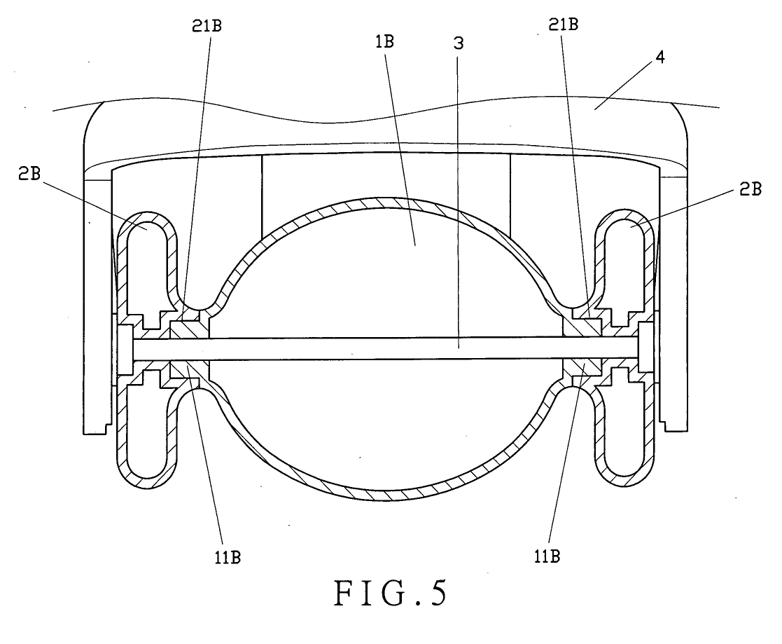

In a third preferred embodiment of the present invention as illustrated in FIG. 5, the outer diameter of each of secondary wheels (2B) is smaller than that of a primary wheel (1B). In this preferred embodiment, the engaging members of the primary wheel (1B) are engaging tubes (11B), and the engaging members of the secondary wheels (2B) are engaging holes (21B). The engaging tubes (11B) of the primary wheel (1B) are engaged with the engaging holes (21B) of the secondary wheels (2B), and then fixed to the wheel axle (3). The wheel axle (3) is pivotally connected to the truck (4).

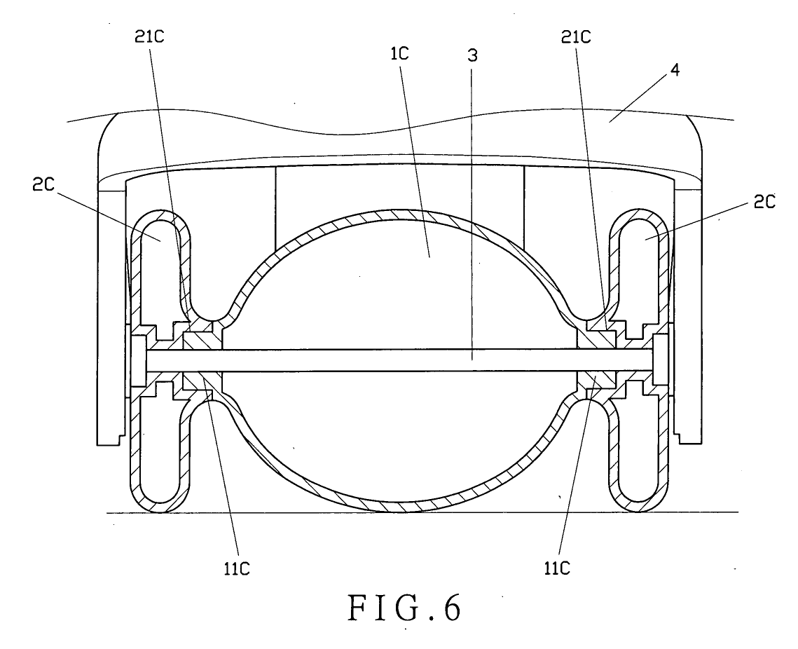

As illustrated in FIG. 6 for a fourth preferred embodiment of the present invention, the outer diameter of a primary wheel (1C) is the same as that of each of secondary wheels (2C) for the wheel set to be composed of multiple wheels. The engaging members of the primary wheel (1C) are engaging tubes (11C), and the engaging members of the secondary wheels (2C) are engaging holes (21C). The engaging tubes (11C) are engaged with the engaging holes (21C), and then fixed to the wheel axle (3). The wheel axle (3) is pivotally connected to the truck (4).

What is claimed is:

1. A wheel set comprising a primary wheel and two secondary wheels, wherein said secondary wheels are disposed at two sides of said primary wheel, respectively, and characterized by:
said primary wheel comprising non-circular engaging members at the two sides; each of said secondary wheels comprising a corresponding non-circular engaging member to be engaged with said primary wheel.

2. The wheel set of claim 1, wherein said engaging members of said primary wheel are engaging holes, and said engaging member of each of said secondary wheels is an engaging tube.

3. The wheel set of claim 1, wherein said engaging members of said primary wheel are engaging tubes, and said engaging member of each of said secondary wheels is an engaging hole.

4. The wheel set of claim 1, wherein each of said engaging members of both said primary wheel and said secondary wheels has a polygonal cross-section.

5. The wheel set of claim 1, wherein each of said secondary wheels has an outer diameter smaller than that of said primary wheel to be an auxiliary wheel.

6. The wheel set of claim 1, wherein said primary wheel and said secondary wheels have the same outer diameter to form multiple wheels.
